(19) United States
(12) Patent Application Publication
(10) Pub. No.: US 2014/0158397 A1
(43) Pub. Date: Jun. 12, 2014

(54) CABLE

(71) Applicant: Hon Hai Precision Industry Co., Ltd., New Taipei (TW)

(72) Inventor: CHEN-FENG SU, New Taipei (TW)

(21) Appl. No.: 13/941,567

(22) Filed: Jul. 15, 2013

(30) Foreign Application Priority Data
Dec. 11, 2012 (TW) 101223974

(51) Int. Cl. H01B 7/08

(52) U.S. Cl. CPC H01B 7/0823
USPC 174/117 F

(57) ABSTRACT

A cable for establishing connection with connectors comprises a plurality of wires parallel and apart from each other, and an insulating structure sandwiching the plurality of wires. The insulating structure comprises a plurality of isolating portions arranged between each of two adjacent wires. Each of the isolating portions comprises a perforated portion.

### BACKGROUND

1. Technical Field

The present disclosure relates to cables, particular relates to a cable for connecting connectors.

2. Description of Related Art

Cables are connected between two connectors. Most the cables include two insulating layers and a number of wires sandwiched between the two insulating layers. In some case, connectors have different pin-out to simultaneously connect to two separated connectors. A connector of a main board simultaneously connects with a connector of an IR board and a connector of a key board. However, the wires of a flexible flat cable are combined together by the insulating layers, thus two cables are needed and some of the wires in some case may be floating or idle. Thus, the idle wires of the cable are wasted.

Therefore, there is room for improvement in the art.

### BRIEF DESCRIPTION OF THE FIGURE

The components of the drawings are not necessarily drawn to scale, the emphasis instead being placed upon clearly illustrating the principles of the embodiment of a cable. Moreover, in the drawings, like reference numerals designate corresponding parts throughout several views.

FIG. 1 is a schematic view of a cable, according to an embodiment.

FIG. 2 exploded view of the cable of FIG. 1.

FIG. 3 is another schematic view of FIG. 1.

FIG. 4 is a schematic view of the cable of FIG. 1 connected three connectors.

### DETAILED DESCRIPTION

Embodiments of the present disclosure will be described in detail with reference to the drawings.

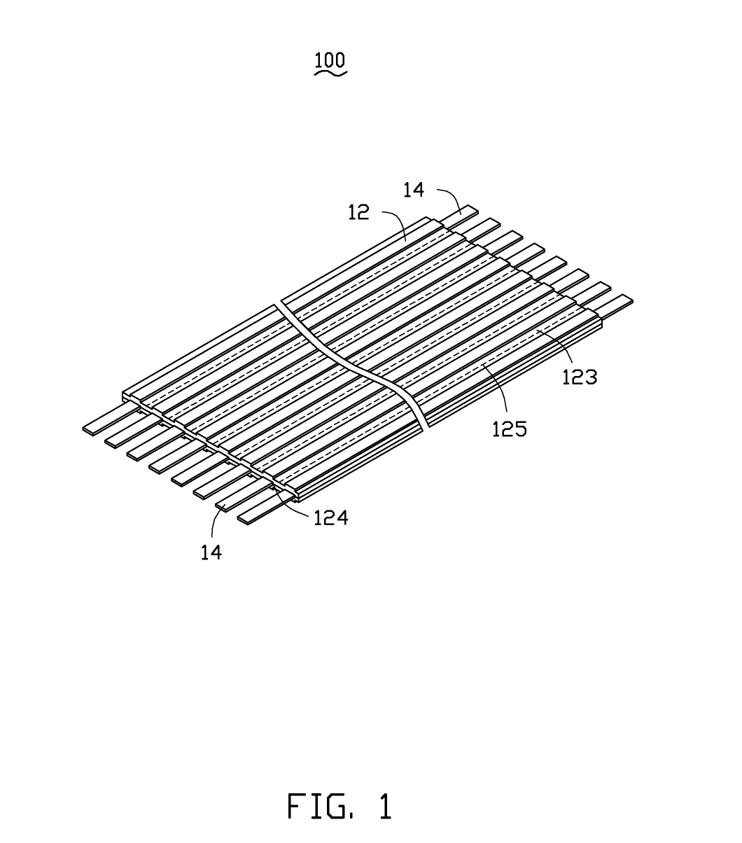

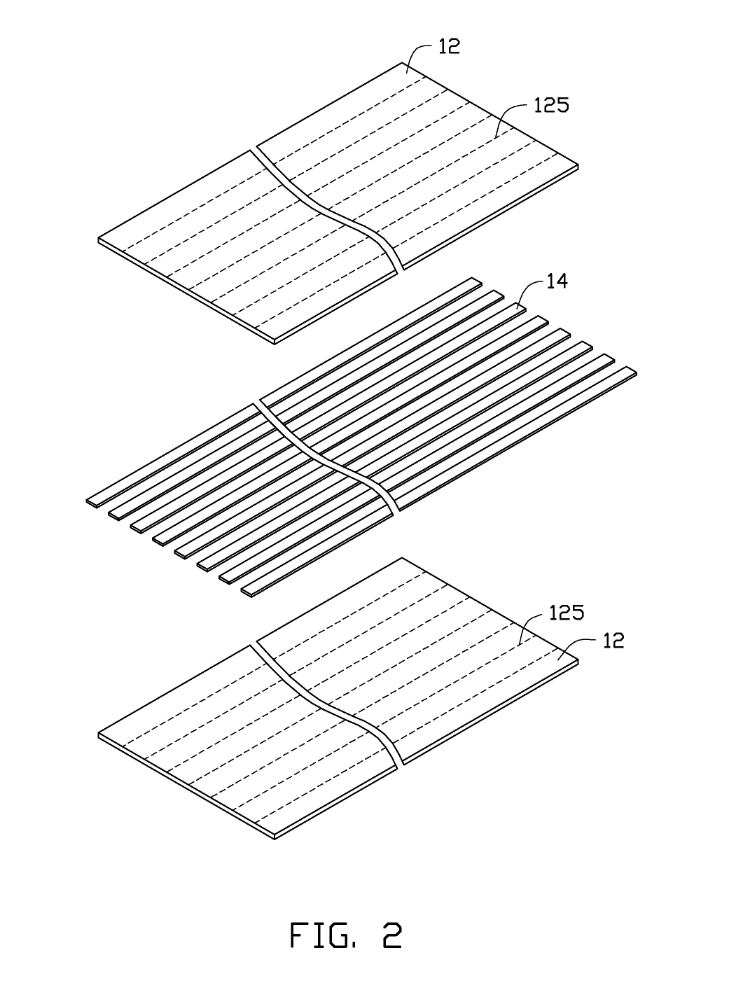

FIGS. 1 and 2 show a cable 100 of the embodiment. The cable 100 is used for connecting connectors. In the embodiment, the cable 100 is a flexible flat cable.

The cable 100 includes two insulating layers 12, and a number of wires 14. The insulating layers 12 are substantially rectangular and pressed to each other for tightly sandwiching the wires 14. The insulating layers 12 cooperatively form a number of isolating portions 123, and a number of receiving portions 124. The isolating portions 123 and the receiving portions 124 are parallel with each other and alternately arranged. The isolating portion 123 prevents the two adjacent wires 14 from connecting with each other. Each of the isolating portions 123 includes a perforated portion 125. The perforated portion 125 is arranged along the longitudinal direction of the insulating layer 12. The perforated portion 125 is combined by a series of holes apart from each other. In the embodiment, each holes of the perforated portion 125 is a straight line, and the lengths of holes are identical. In other embodiments, each holes of the perforated portions 125 also is a straight line, but the lengths of the holes of the portions 125 can be different and the distance between two adjacent holes of the perforated portions 125 are different; or the perforated portions 125 can be curved; or the holes of the perforated portion 125 also can be a blind hole. The receiving portion 124 is substantially rectangular and receives the wires 14. Each of receiving portions 124 have two opposite sides projecting downwards and upwards with respect the isolating portion 123 correspondingly.

The wires 14 are parallel with each other and disposed in the receiving portion 124. Opposite ends of the conductive terminal 14 respectively extend out of the corresponding receiving portion 124.

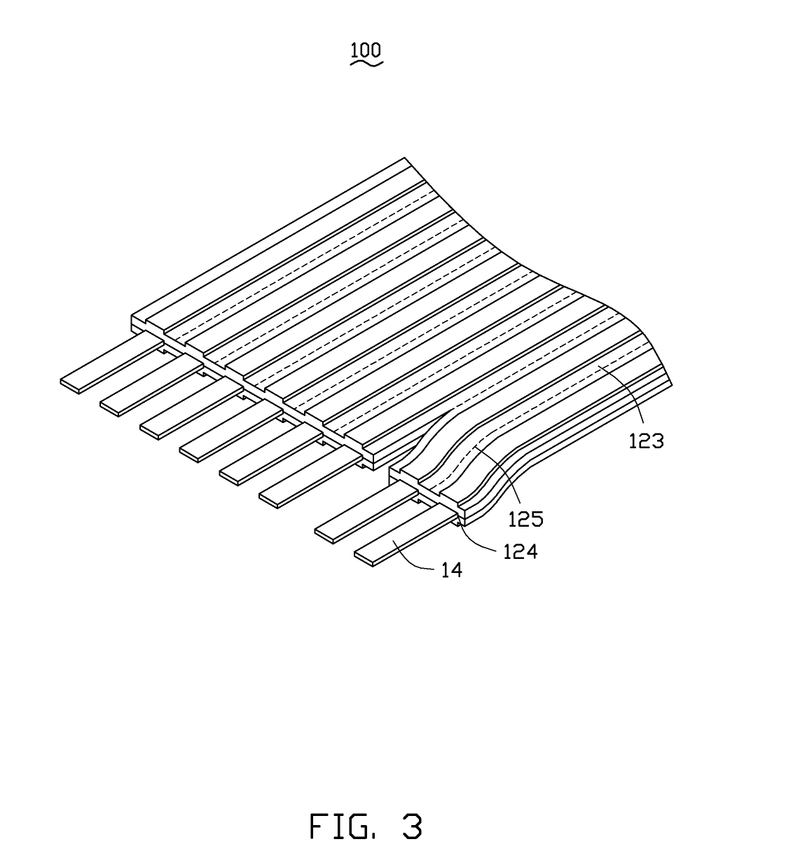

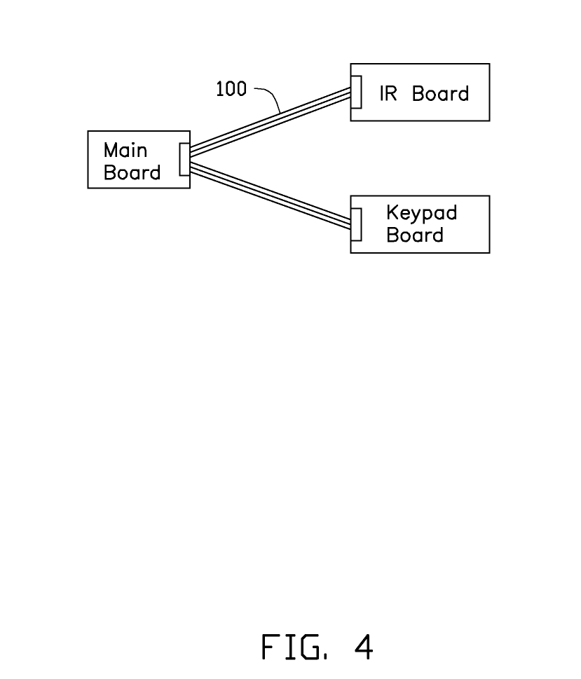

FIG. 3 shows the cable 100 of the embodiment. An end of each isolating portion 123 can be ripped along the perforated portion 125 to separate an end of the cable 100 into at least two parts. As shown in FIG. 4, one end of the cable 100 connects to connector of a main board, and the two ripped off parts of the cable 100 respectively connect to a connector of a IR board and a connector of a keypad board, and the cable 100 simultaneously three connectors together.

As described, an end of the cable 100 can be separated into at least two parts, to cause the wires 14 to be divided into at least two parts, such that, the end of the cable 100 can simultaneously connected to at least two connectors. Therefore, the connection ability of the cable 100 is improved.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A cable comprising:
a plurality of wires parallel and apart from each other; and
an insulating structure sandwiching the plurality of wires; the insulating structure comprising a plurality of isolating portions being arranged between each of two adjacent wires;
wherein each of the isolating portions comprises a perforated portion.

2. The cable of claim 1, wherein the perforated portion is arranged parallel to the plurality of wires and is a series of holes.

3. The cable of claim 2, wherein the lengths of the holes of perforated portion are identical.

4. The cable of claim 2, wherein the lengths of the holes of the perforated portion are different.

5. The cable of claim 2, wherein the distance between two adjacent holes of the perforated portion are identical.

6. The cable of claim 2, wherein the distance between two adjacent holes of the perforated portion are different.

7. The cable of claim 1, wherein the insulating structure comprises a number of isolating portions and a number of receiving portions; the isolating portions and the receiving portion are parallel with each other and alternately arranged.

8. The cable of claim 7, wherein each of receiving portions have two opposite sides; one side of the receiving portion is projected downwards with respect the isolating portion and the opposite side of the receiving portion is projected upwards with respect the isolating portion correspondingly.

9. A cable comprising:
a plurality of wires;
a plurality of receiving portions, each of the receiving portions receiving one wire correspondingly; and
a plurality of isolating portions, the isolating portions and the receiving portion being arranged alternately;
wherein each of the isolating portions comprises a perforated portion; one end of the cable can be separated into at least two parts along the perforated portion causing the wires divided into at least two parts for respectively connecting at least two connectors.

10. The cable of claim 9, wherein the perforated portion is arranged along the length of the plurality of wires and is combined by a series of holes.

11. The cable of claim 9, wherein the lengths of the holes of the perforated portions are identical.

12. The cable of claim 11, wherein the lengths of the holes of the perforated portions are different.

13. The cable of claim 11, wherein the distance between two adjacent holes of the perforated portion are different.

14. The cable of claim 11, wherein the distance between two adjacent holes of the perforated portion are identical.

15. The cable of claim 9, wherein each of receiving portions have two opposite sides; one side of the receiving portion is projected downwards with respect the isolating portion and the opposite side of the receiving portion is projected upwards with respect the isolating portion correspondingly.
